(19) United States
(12) Patent Application Publication
(10) Pub. No.: US 2006/0204001 A1
(43) Pub. Date: Sep. 14, 2006

(54) Telephone hands-free system

(76) Inventor: Roman Piekarz, Mielec (PL)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/366,807

(22) Filed: Mar. 3, 2006

(30) Foreign Application Priority Data
Mar. 9, 2005 (DE) 20 2005 004 075.4

(51) Int. Cl. H04M 1/00

(52) U.S. Cl. 379/433.01

(57) ABSTRACT

A telephone hands-free system for a mobile telephone, having a holder (1), which has electronics, for connection of the mobile telephone by means of a contact arrangement which is arranged in the holder (1) and can be connected to contacts of the mobile telephone, and having a control arrangement for controlling at least the hands-free function, can be designed with as little complexity as possible and such that it can be handled easily in that the control arrangement is accommodated in the holder, and in that a connecting box (6) with plug connecting devices (8, 14, 17) is connected via a cable (4) to the holder, by means of which plug connecting devices (8, 14, 17) the electronics in the holder (1) can be connected to external appliances of the hands-free system.

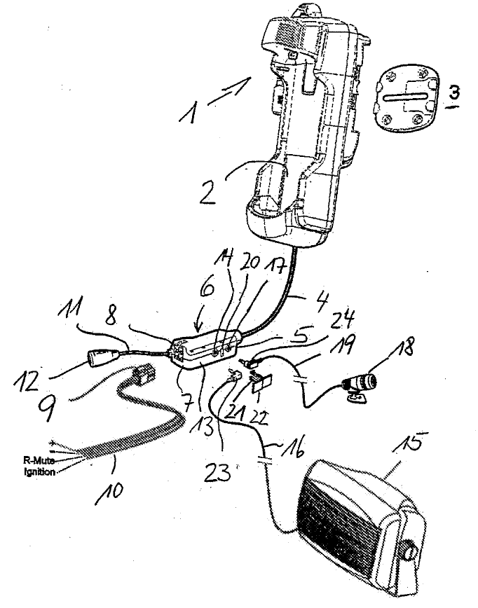

The invention relates to a telephone hands-free system for a mobile telephone, having a holder, which has electronics, for connection of the mobile telephone by means of a contact arrangement which is arranged in the holder and can be connected to contacts of the mobile telephone, and having a control arrangement for controlling at least the hands-free function.

Known telephone hands-free systems, in particular such as those installed in motor vehicles, have a control box, in which the control arrangement is accommodated, in addition to the holder.

In this case, it is known for the holder to have only passive components, such as plug connectors and cable connections, and for the complete control system to be accommodated in the control box. In consequence, the control box must be specifically designed for the respective telephone, so that changing a mobile telephone also results in the control box being changed.

In another known embodiment, the holder is matched to the mobile telephone which it is intended to hold, in terms of the size and of the contacts which are specific for that mobile telephone, and has an appropriate contact arrangement. The holder can be connected to the control box by means of a standard connecting layout, so that a plurality of holders which are intended for different mobile telephones can be connected to the control box, which is normally permanently installed in the motor vehicle. The electronics in the holder may in this case be provided for all functions which are related to a specific type of mobile telephone, while the other functions are carried out in the control box. Functions of the holder could in this case comprise the audio signal in the downlink direction (in the direction of the control box) being matched to a standardized level, the audio signal in the uplink direction (in the direction of the mobile telephone) being matched to the mobile telephone, noise and echo suppression being provided, communication taking place with the mobile telephone in order to receive the status of the mobile telephone or to carry out telephone control operations such as switching on the hands-free mode, and, in addition, providing a charging voltage and a suitable charging current for the mobile telephone. The control functions in the control box may comprise the amplification of the audio signal in order to drive an external loudspeaker, the provision of the microphone supply voltage, the filtering of the vehicle supply voltage, the protection of the supply voltage against short-circuits, passing on a signal which is produced by the vehicle which characterizes the ignition being switched on, and the production of a control signal for radio muting.

When the functions are subdivided in this way, the control box can be permanently installed in the motor vehicle, and can interact with different holders. Replacement of a mobile telephone therefore requires only replacement of a holder, but not also replacement of the control box. However, this arrangement means that both the holder and the control box must be fitted with active electronics.

The present invention is based on the object of designing a telephone hands-free system of the type mentioned initially to be as simple as possible and such that it can be handled easily.

According to the invention, in order to achieve this object, the telephone hands-free system of the type mentioned initially is distinguished in that the control arrangement is accommodated in the holder, and in that a connecting box with plug connecting devices is connected via a cable to the holder, by means of which plug connecting devices the electronics in the holder can be connected to external appliances of the hands-free system.

In the case of the telephone hands-free system according to the invention, the entire control system is thus provided in the holder. The holder is located within reach of the user, in a motor vehicle generally in the area of the dashboard or of the center console. In order to avoid the production of unsightly cable runs for connection to the holder in this visible area, the invention provides that the holder is connected to a connecting box, which can be fitted in the motor vehicle, by means of a cable, by means of which connecting box the electronics in the holder can be connected to external appliances, such as a loudspeaker and microphone for the hands-free device. The connecting box accordingly typically contains no active electronic components, but is used only to connect the various external components to the connecting cable and/or the holder. If required, a filter device for filtering the supply voltage can be arranged in the connecting box, so that no interference is transmitted from the supply voltage to the hands-free device. The housing of the connecting box can thus be designed to be very small and to cost little. No control box as was previously customary, is therefore any longer fitted in the installation, thus avoiding the increasing space problems which otherwise result from the increase in complexity of the vehicle electronics. The small connecting box which is provided according to the invention can in contrast always be accommodated at desired positions with little space being required. When the mobile telephone is changed, only the holder, possibly including the connecting cable and connecting box, is replaced. All the other components such as the microphone, loudspeaker, connecting cable and antenna remain fitted and just have their connections changed.

For connection of the antenna, the housing preferably has a connection for an antenna plug, in which case the antenna plug may be located on an antenna cable piece which is passed out of the housing.

In one advantageous design solution, the housing is elongated with a first and a second small end wall, and with larger casing walls opposite. The housing then preferably has a cable entry for the connecting cable on the first end wall, has the plug connecting device for the control and supply cable on the second end wall, and has the plug connecting devices for the loudspeaker cable and for the microphone cable on a casing wall.

In this case, the plug connecting devices for the loudspeaker cable and for the microphone cable can be formed by plug sockets.

The housing, which can be used universally, can then even be used, for example, when the hands-free system does not have its own loudspeaker and a hands-free loudspeaker of the mobile telephone is used. However, in this case, it is expedient to close the plug socket for the loudspeaker cable with a cover. The housing therefore preferably has a latching receptacle into which the cover, which in any case closes the plug socket for the loudspeaker cable, can be latched. The cover can furthermore be designed such that it is also intended to close the microphone socket. It is also possible to design the cover such that it covers and thus secures the inserted plug of the loudspeaker cable and of the microphone cable.

The telephone hands-free system according to the invention is preferably used in a motor vehicle. The holder can accordingly be attached to a holding panel which can be mounted on the dashboard of a vehicle.

However, of course, it is also possible to additionally use the telephone hands-free system according to the invention outside a motor vehicle, for example at a workplace at which the mobile telephone can be used, for example also with a headset.

The invention will be explained in more detail in the following text with reference to one exemplary embodiment, which is illustrated in the drawing.

The drawing shows a holder 1 which has a holding area 2, which is open at the front, for holding a mobile telephone (which is not illustrated). The holding area 2 is provided on its lower edge with a contact arrangement (which is not illustrated), by means of which contact can be made with the contacts which are located on a mobile telephone. Furthermore, the holder 1 may be intended to make contact with an antenna input of the mobile telephone.

The holder 1 in the illustrated exemplary embodiment can be mounted by its rear face on a mounting panel 3, which can itself be mounted on the dashboard in a motor vehicle.

A connecting cable 4 is passed out of the holder 1 at the lower end and towards the rear face, and is inserted into a first end wall 5 of a housing of a connecting box 6. In addition to the first small end wall 5, the housing 6 has an opposite second small end wall 7, in which a plug socket 8 is arranged which is intended for connection to a corresponding plug 9 on a control and supply cable 10. A short antenna cable piece 11 is passed out of the housing 6 at the side edge of the second end wall 7, and opens into an antenna socket 12. The control and supply cable 10 contains two conductors +, − for supplying a supply voltage (battery voltage of the motor vehicle), and two conductors for transmission of a signal which characterizes that the ignition has been switched on (standardized terminal 15 for the motor vehicle electronics), and for transmission of a signal for muting the car radio (R mute).

The housing has an essentially rectangular cross section and is provided with four casing walls 13, which are designed to be considerably larger than the end walls 5, 7. The housing 6 is accordingly an elongated housing with relatively small end walls 5, 7.

A plug socket 14 for a loudspeaker cable 16, which is connected to a loudspeaker 15, is arranged on one of the casing walls 13. A plug socket 17 for a microphone cable 19, which is connected to a microphone 18, is positioned adjacent in the longitudinal direction of the housing 6. A latching receptacle 20 is located between the two plug sockets 14, 17, into which two latching limbs 21 of a cover 22 can be snapped, so that the two sockets 14, 17 can be closed by the cover 22 when it is not intended to connect a loudspeaker 15 and/or a microphone 18.

The loudspeaker cable 16 and the microphone cable 19 are, of course, provided with appropriate conventional plugs 23, 24 which can be plugged into the plug sockets 14 and 17, respectively, in order to make contact.

The telephone hands-free system according to the invention thus allocates to the holder 1 the connection options for the loudspeaker 15, for the microphone 18 and, if required, for an antenna (via the antenna plug 12) without contact having to be made on the visible side of the dashboard—when arranged in a motor vehicle. In fact, contact is made—including with the control and supply cable—on the universal housing 6, which is arranged outside the holder 1, with a single connecting cable 4, behind the dashboard.

1. A telephone hands-free system for a mobile telephone, having a holder (1), which has electronics, for connection of the mobile telephone by means of a contact arrangement which is arranged in the holder (1) and can be connected to contacts of the mobile telephone, and having a control arrangement for controlling at least the hands-free function, wherein the control arrangement is accommodated in the holder, and wherein a connecting box (6) with plug connecting devices (8, 14, 17) is connected via a cable (4) to the holder, by means of which plug connecting devices (8, 14, 17) the electronics in the holder (1) can be connected to external appliances of the hands-free system.

2. The telephone hands-free system as claimed in claim 1, wherein the plug connecting devices (14, 17) are provided at least for a loudspeaker cable (16) which leads to a loudspeaker (15), and for a microphone cable (19) which leads to a microphone (18).

3. The telephone hands-free system as claimed in claim 1, wherein a plug connecting device (8) is also provided for a control and supply cable (10).

4. The telephone hands-free system as claimed in claim 1, wherein the housing (6) is also provided with a connection (11) for an antenna plug (12).

5. The telephone hands-free system as claimed in claim 4, wherein the antenna plug (12) is located on an antenna cable piece (11) which is passed out of the housing (6).

6. The telephone hands-free system as claimed in claim 1, wherein the housing (6) is elongated with a first and a second small end wall (5, 7), and with larger casing walls (13) opposite.

7. The telephone hands-free system as claimed in claim 6, wherein the housing (6) has a cable entry for the connecting cable (4) on the first end wall (5), has the plug connecting device (8) for the control and supply cable (10) on the second end wall (7), and has the plug connecting devices (14, 17) for the loudspeaker cable (16) and for the microphone cable (19) on a casing wall (13).

8. The telephone hands-free system as claimed in claim 1, wherein the plug connecting devices for the loudspeaker cable (16) and for the microphone cable (19) are formed by plug sockets (14, 17).

9. The telephone hands-free system as claimed in claim 1, comprising at least one latching receptacle (20) in the housing (6) for a cover (22) which closes at least the plug socket (14) for the loudspeaker cable (16).

10. The telephone hands-free system as claimed in claim 9, wherein the cover (22) is also provided for closure of the plug socket (17) for the microphone cable (19).

11. The telephone hands-free system as claimed in claim 1, wherein the holder (1) can be attached to a holding panel (3) which can be mounted on the dashboard of a vehicle.
